(19) United States
(12) Patent Application Publication
(10) Pub. No.: US 2003/0075057 A1
(43) Pub. Date: Apr. 24, 2003

(54) Apparatus for making sweetened beverages

(76) Inventors: Craig Saunders, Rocky River, OH (US); Marc L. Vitantonio, S. Russel, OH (US); John R. Nottingham, Bratenahl, OH (US); John W. Spirk, Gates Mills, OH (US)

Correspondence Address: SONNENSCHEIN NATH & ROSENTHAL, P.O. BOX 061080, WACKER DRIVE STATION, CHICAGO, IL, 60606-1080, US

(21) Appl. No.: 10/264,808

(22) Filed: Oct. 4, 2002

Related U.S. Application Data
(60) Provisional application No. 60/326,946, filed on Oct. 4, 2001.

(51) Int. Cl. A23N 1/00; A23L 1/00

(52) U.S. Cl. 99/495; 99/348; 99/511; 99/501; 99/506

(57) ABSTRACT

An apparatus for mixing a beverage includes a reservoir for receiving a predetermined amount of liquid; a mixing chamber for receiving a predetermined level of a powdered material; and a manifold having an outlet to deliver the liquid from the reservoir to the mixing chamber, where the outlet is disposed below the predetermined level of the powdered material.

The present invention relates to an apparatus for making sweetened beverages, such as lemonade. In particular, the present invention relates to a juice extractor with the capability of adding sugar and water to achieve a sweetened beverage.

### BACKGROUND OF THE INVENTION

Juice extractors are well-known in the art. A conventional juice extractor includes a reamer whereby a fruit is manually pressed and rotated against the reamer in order to extract juice from the fruit. The extracted juice is then typically collected in a receptacle and manually mixed with water by shaking or stirring.

Prior improvements to the conventional juice extractor have included a mixing apparatus to automatically mix the extracted juices in the receptacle. For example, U.S. Pat. No. 6,070,519 teaches a mixing paddle disposed in the receptacle. When the reamer is actuated by a drive motor, the mixing paddle is simultaneously actuated to agitate the juices in the receptacle, thereby mixing the extracted juices with the water.

However, when mixing beverages such as lemonade, the user often also adds powdered sweeteners such as sugar. Mechanical agitation of the juices is generally insufficient to provide adequate mixing of the sugar with the juices and water in the receptacle. As such, there is a need to provide an apparatus that can automatically and sufficiently mix sugar with the water and the extracted juices in order to make a sweetened beverage.

### SUMMARY OF THE INVENTION

One object of the present invention is to provide an apparatus for mixing a beverage, the apparatus which includes a reservoir for receiving a predetermined amount of liquid, and a heating system which heats the liquid. The apparatus also includes a mixing chamber for receiving a predetermined level of a powdered material. Finally, the device includes a manifold.

In one embodiment, the manifold includes an outlet to deliver the liquid from the reservoir to the mixing chamber. The outlet also may have at least one aperture and is disposed below the predetermined level of the powdered material in the mixing chamber. The outlet may also be positioned proximate to the mixing chamber floor as well as proximate to a mixing chamber outer wall opposite the dividing wall.

The manifold may also include an upper portion having an air hole and a valve to prevent the “back flow” of liquid from the mixing chamber to the reservoir. This upper portion may be situated above the predetermined level of powdered material. In one approach, the valve is a flap valve.

The present invention may also include a draining chamber separated from the mixing chamber by a dividing wall. The mixing chamber may includes an exit port, such as an aperture, located on the dividing wall. The mixing chamber may further include an overflow aperture disposed on a higher portion of a dividing wall than the exit port.

The draining chamber may include an inclined trough. The inclined trough may be a circular inclined trough disposed adjacent to an outer wall of the draining chamber such that an upper portion of the circular inclined trough is proximate to the exit port and a lower portion of the circular inclined trough is proximate to a drain hole.

The present invention may further include a reamer above the draining chamber for extracting juice from a food product The device may also include a reamer motor and a drive shaft such that the reamer motor engages the drive shaft in order to rotate the reamer. In one embodiment, the reamer motor is actuated in response to a predetermined amount of pressure on the reamer. The present invention may also be designed to rotate in a first rotational direction in response to the predetermined amount of pressure on the reamer. Then, if a predetermined amount of rotational torque is sensed, the reamer 30 will cease its rotation in the first rotational direction and begin rotation in a second rotational direction

The present invention may further include a receptacle for receiving and containing the beverage. The receptacle may be fluid coupled to the draining chamber via a drain hole in the draining chamber. The receptacle may include a concave receptacle lid. This lid may have an aperture to allow liquid to flow into the receptacle.

The present invention further involves a method for mixing a beverage comprising the steps of receiving a predetermined amount of heated liquid in a reservoir; receiving a predetermined level of powdered material in a mixing chamber, and delivering a heated liquid from the reservoir to the mixing chamber at a level below the predetermined level of powdered material.

There has thus been outlined, rather broadly, some features consistent with the present invention in order that the detailed description thereof that follows may be better understood, and in order that the present contribution to the art may be better appreciated. There are, of course, additional features consistent with the present invention that will be described below and which will form the subject matter of the claims appended hereto.

In this respect, before explaining at least one embodiment consistent with the present invention in detail, it is to be understood that the invention is not limited in its application to the details of construction and to the arrangements of the components set forth in the following description or illustrated in the drawings. Methods and apparatuses consistent with the present invention are capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the methods and apparatuses consistent with the present invention.

### BRIEF DESCRIPTION OF THE DRAWINGS

FIG. 1 is a exploded plan view of one embodiment of an apparatus for making sweetened beverages;

FIG. 2 is a cross-sectional view of one embodiment of an apparatus for making sweetened beverages

FIG. 3 is a top view of one embodiment of a lower basket of the apparatus for making sweetened beverages;

FIG. 4 is a perspective view of one embodiment of the lower basket of the apparatus for making sweetened beverages;

FIG. 5 is a cross-sectional view of one embodiment of a mixing chamber of the apparatus for making sweetened beverages;

FIG. 6 is a schematic view of one embodiment of a manifold of the apparatus for making sweetened beverages.

### DETAILED DESCRIPTION OF THE PREFERRED EMBODIMENTS

While the present invention may be embodied in many different forms, there is shown in the drawings and discussed herein a few specific embodiments with the understanding that the present disclosure is to be considered only as an exemplification of the principles of the invention and is not intended to limit the invention to the embodiments illustrated.

Further, in the drawings, like reference numerals refer to like elements of the present invention in the various drawings, for more convenient reference.

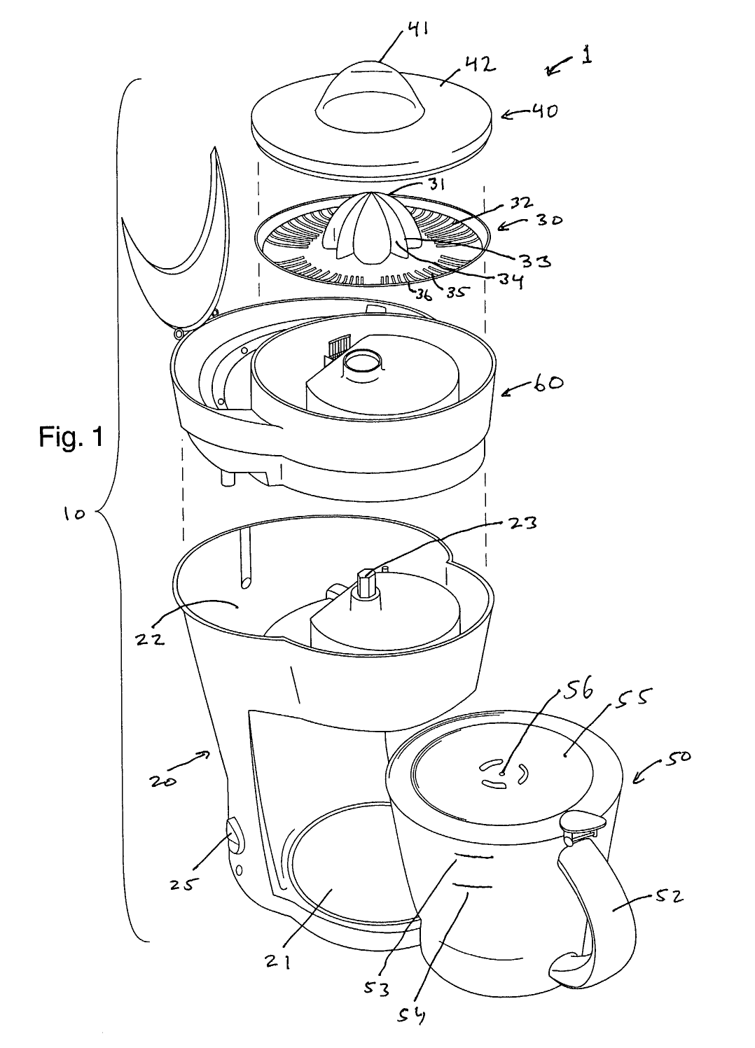

FIG. 1 shows an apparatus 1 for making sweetened beverages such as lemonade, limeaid and other powdered sweetened beverages. The apparatus 1 includes a base unit 10 and a separate receptacle 50 for receiving and containing the beverage. In one embodiment, the base unit 10 includes a main body 20 which holds the receptacle, a lower basket 60 disposed in the main body 20, a reamer 30 which is disposed on the lower basket 60, and a reamer cap 40 which covers the reamer 30.

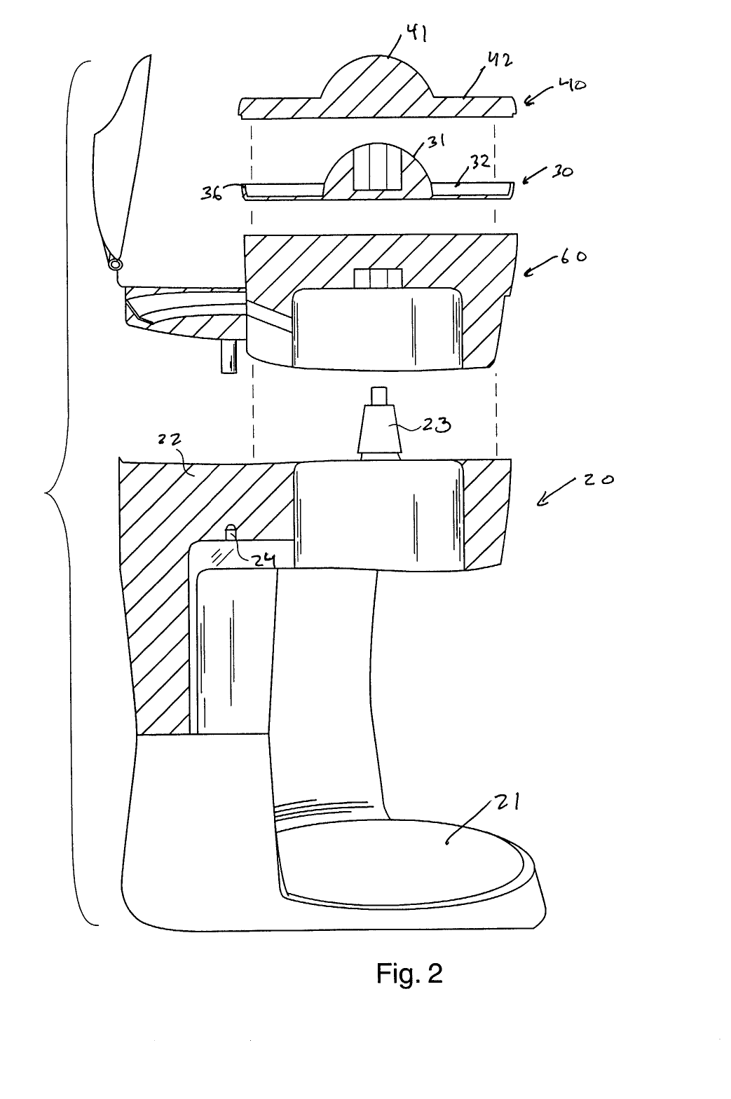

In one embodiment of the present invention, the main body 20 may also include a base plate 21, a reservoir 22, a reamer motor (not shown), a drive shaft 23, and a hot water inlet 24 (see FIG. 2). The base plate 21 is a flat portion which is designed to hold the receptacle 50 and is in substantially the same shape as the lower portion of the receptacle 50 (i.e., in this case, a circular shape). However, the main body 20 may alternatively be designed without a base plate, allowing the receptacle 50 to sit on a countertop or other surface.

In one embodiment, a vertical portion of the main body 20 connects the base plate 21 and the reservoir 22. The reservoir 22 may be formed by making a hollow inner cavity in the upper portion of the main body 20. In one embodiment of the invention, the reservoir 22 is large enough to accept approximately 17.5 ounces of liquid, and has a heating element.

The reservoir 22 is disposed underneath the lower basket 60 of the base unit 10, and thus, would be accessed by removing the lower basket 60 from the apparatus 1. Alternatively, the heating reservoir 22 may be placed to the side of the lower basket 60 to allow for access to the reservoir 22 without removing any other parts. A heating element (not shown) is disposed within the main body 20 for heating liquid from the reservoir 22. The heating element may be energized by depressing an ON/OFF switch 25 located on the side of the base unit 10 to the ON position (see FIG. 2). The switch 25 connects power to the heating element via a plug and line(not shown).

The reamer 30 may be located above the lower basket 60. In one approach, the reamer 30 may sit partially within the lower basket 60. The reamer 30 has a centrally-disposed bell-shaped inner portion 31 extending into a flat circular bottom 32. A plurality of ridges 33 and troughs 34 extend longitudinally from the apex of the bell shaped inner portion 31. The flat circular bottom 32 includes a plurality of slit shaped apertures 35 that extend radially from the inner portion 31, and the apertures 35 are sized to allow the throughflow of liquid but to prevent the throughflow of solids such as seeds. A upwardly-turned flange 36 extends around the perimeter of the bottom of the reamer 30 to prevent solids such as seeds, from overflowing the reamer 30.

The reamer 30 may be driven by a reamer motor and a drive shaft 23 in the main body. The reamer motor engages the vertical drive shaft 23 which rotates the reamer 30. In one embodiment of the present invention, the reamer 30 is rotated by the drive shaft 23 during the application of pressure on the bell shaped inner portion 31. In this approach, when the user places pressure onto the top of the bell shaped inner portion 31, such as, by placing fruit on the inner portion 31 and pressing the fruit downwardly on the inner portion 31, the resulting pressure actuates the reamer motor such that the reamer 30 will begin to rotate and extract the juice from the fruit. Once the fruit is removed from the reamer 30, there is no longer any pressure and the reamer motor ceases, thus stopping the rotation of the reamer 30. Alternatively, the reamer motor may be designed to operate continually for a predetermined period of time after the actuation of the ON/OFF switch 25.

Furthermore, in another embodiment of the present invention, the reamer 30 may also be designed to sense a predetermined rotational torque level using a torque sensor (not shown). Once the predetermined amount of rotational torque is exceeded by the reamer 30, the reamer 30 will stop its rotation and then begin to rotate in the opposite direction. This prolongs the life of the motor and aids in the extraction of juice from the fruit.

A reamer cap 40 is removably attached to the reamer 30. The reamer cap 40 may be similar in shape to the reamer 30 such that the reamer cap 40 may also have a bell shaped inner portion 41, the base of which extends radially into a generally flat, flanged circular bottom 42. This allows for the reamer cap 40 to be positioned on top of the reamer 30 when the reamer 30 is not in use.

The reamer cap 40 may also be used to assist in the extraction of juice from the fruit. For example, a user may place the fruit onto the bell shaped inner portion 31 of the reamer 30. The user may then press the reamer cap 40 onto the fruit. This action applies pressure onto the fruit and the reamer and, thus, actuates the reamer motor. By using the reamer cap 40 to apply pressure instead of pressing on the fruit manually, the process of extracting the juice from the fruit may be cleaner and require less force by the user.

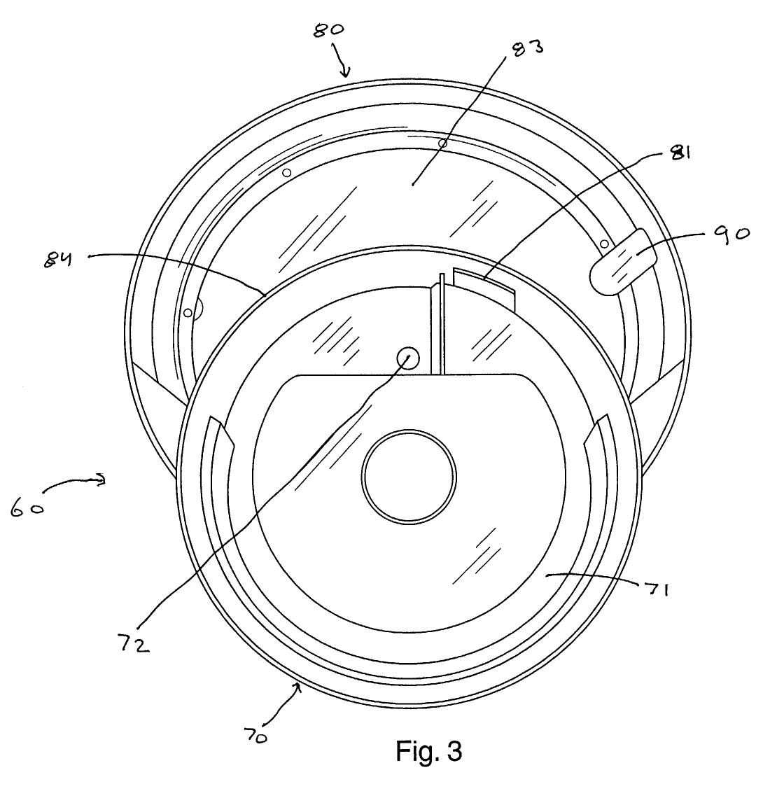

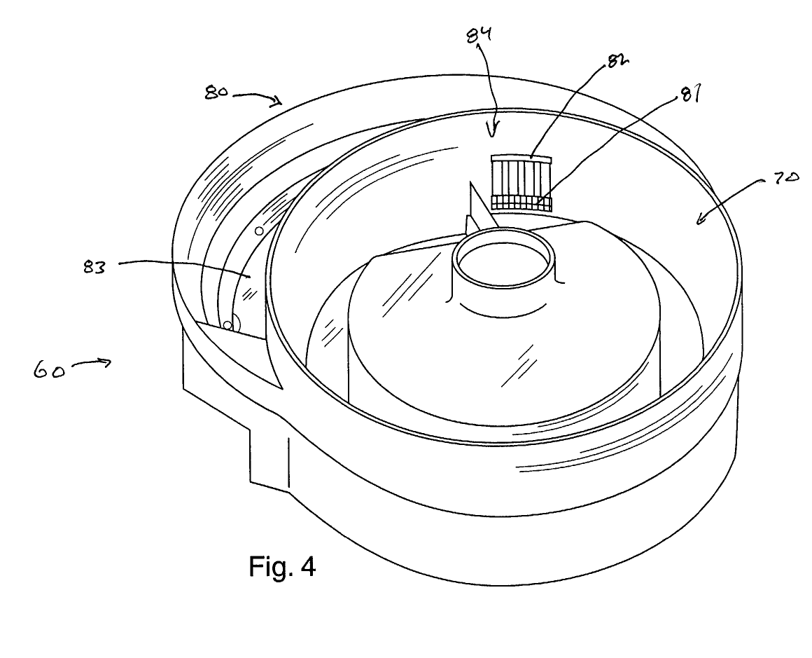

The lower basket 60 is comprised of a draining chamber 70, a mixing chamber 80, and a manifold 90. (see FIGS. 3 and 4) The lower basket 60 is preferably removably attached to the main body 20. This allows the lower basket 60 to be detached from the main body 20 to aid in filling the lower basket 60 and may also make it easier to clean. However, the lower basket 60 may alternatively be integral to the main body without affecting the functionality of the appliance. The lower basket 60 may also include legs in the front and back of the basket, allowing for the lower basket 60 to stand upright when removed from the main body 20. When attached to the main body 20, the lower basket 60 is operably associated with the heating reservoir 22 and receptacle 50.

In the approach shown in the figures, the mixing chamber 80 is generally semicircular in shape and is large enough to receive approximately one cup of sugar or other powdered material (e.g., a presweetened drink mix). The mixing chamber 80 is also preferably large enough so that water heated in the reservoir 22 can sufficiently submerge the sugar that is placed into the mixing chamber 80. The mixing chamber 80 is fluid-coupled to the draining chamber 70 via an exit port 81 in a dividing wall 84 between the two chambers. In one embodiment of the present invention, the exit port 81 is a series of apertures. Alternatively, the exit port 81 may also be a single aperture or a molded screen. The size of the apertures in the exit port 81 control the rate of flow of the “sugar water” out of the mixing chamber 80. The rate of flow out of the mixing chamber 80 is designed to be significantly less than the rate of flow of hot water entering the mixing chamber 80 through the manifold 90. This results in a higher level of hot water in the mixing chamber 80 to more completely dissolve the sugar into the water.

The mixing chamber 80 may further include an overflow aperture 82 on the dividing wall 84 between the mixing chamber 80 and the draining chamber 70. The overflow aperture 82 is placed sufficiently above the floor 83 of the mixing chamber 80 to allow a desired accumulation of water in the mixing chamber 80. The overflow aperture 82 in one embodiment may be a horizontal slit located above the exit port 81 and approximately midway up the dividing wall 84. However, the overflow aperture 82 may be located anywhere on the dividing wall 84. The aperture 82 may also be of any shape including the shape of a notch on the top of the dividing wall 84. The overflow aperture 82 allows “sugar water” from the mixing chamber 80 to flow into the draining chamber 70 once a predetermined level has been reached. This prevents the “sugar water” from overflowing out of the apparatus 1.

In one embodiment, the floor 83 of the mixing chamber 80 may be sloped down towards the dividing wall 84. This aids in moving the “sugar water” in the mixing chamber towards the exit port 81.

A flip lid 61 may also be hinged onto the lower basket 60 and can be opened to access the mixing chamber 80. Once sugar is poured into the mixing chamber 80, the flip-lid 61 may be closed to avoid contamination or spilling.

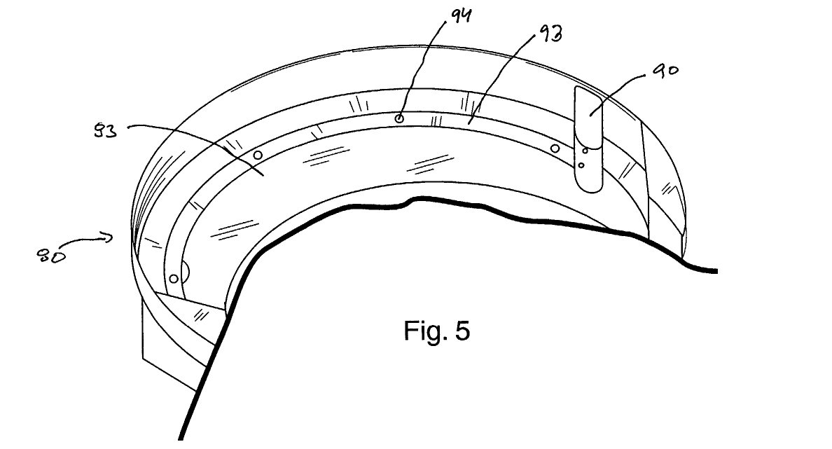

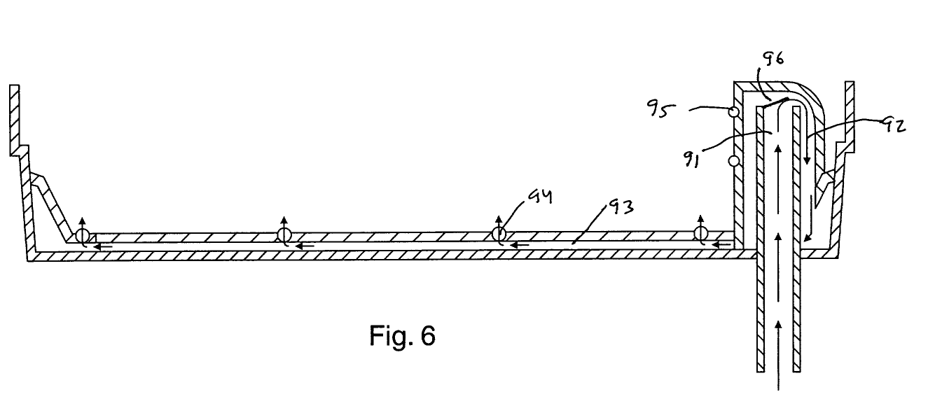

As shown in FIGS. 3 and 5, the manifold 90 is located within the mixing chamber 80. The manifold 90 is fluid-coupled to the heating reservoir 22 through inlet 24. In one embodiment, the manifold 90 includes a first vertical chamber 91 (operably connected to inlet 24), a second vertical chamber 92 fluid coupled to the first vertical chamber 91, and a generally horizontal tube outlet 93. (see FIG. 6). A plurality of holes or apertures 94 may be disposed along the top of the horizontal tube outlet 93. However, the horizontal tube outlet 93 may instead have slits instead of apertures 94. The slits and/or apertures 94 may also be located anywhere along the horizontal tube outlet 93, including along the side or bottom of the tube outlet 93.

The manifold 90 is preferably enclosed except for the slits or holes 94. In this way, the heated water can only escape through the slits or holes 94. This aids in spreading the hot water throughout the bottom of the mixing chamber along its floor rather than from above, and also helps harness the steam pressure built up by the heated water, which provides a surging pressure to agitate the sugar water. Without this sealed chamber 90, much of the energy in the surging hot water would be dissipated and would not aid in stirring up the “sugar water.”

In one embodiment, the horizontal outlet tube 93 is adjacent to the floor 83 of the mixing chamber 80. The manifold holes 94 are also preferably positioned adjacent the wall opposite the exit port 81 to better ensure that the heated water coming from the reservoir 22 is allowed to melt the sugar prior to flowing out the exit port 81. In the approach shown in the Figures, the manifold 90 is formed integrally with the lower basket 60. However, the manifold 90 may also be constructed separately, such that the horizontal tube outlet 93 is self enclosed.

The manifold 90 may further include an air hole 95 and a valve 96 at the upper portion of the manifold 90 (see FIG. 6). As the hot water and steam rises up the first vertical tube 91, the valve 96 seals off the top air hole 95. The valve 96 would control any suction pressure causing a reversal of sugar water into the first vertical chamber 91, and subsequently into the heating reservoir 22. Thus, the valve 96 aids in the long-term operation of the apparatus 1. This ensures that nearly all the available energy of the hot water surge is directed through the manifold 90 and into the mixing chamber 80. As the hot water/steam surge ends, there is a “back-draft” created that tries to pull any water and air back down the first vertical tube 91 to the heater in the reservoir 22. The flap valve 96 allows “fresh” air to be drawn into the top of the manifold 90 via the air hole 95, thereby negating any suction pressure to pull sugar water back into the system. The valve 96 is preferably a flap valve constructed out of rubber. Alternatively, a ball check valve or a duck bill valve may also be used.

The height of the manifold 90 is also chosen in relation to the pressure of the rising heated water. As the water level in the mixing chamber 80 rises (due to water flow out of the manifold 90), the pressure of the water above the holes 94 in the horizontal tube outlet 93 also rises. The water exiting the horizontal outlet tube 93 should be capable of overcoming a sufficient mount of pressure such that water exiting the horizontal tube 93 can sufficiently submerge the sugar in the mixing chamber 80.

The design of the manifold 90 may also be used to aid or replace the overflow aperture 82 in controlling the level of heated water entering the mixing chamber 80. For example, the manifold 90 may be designed such that heated water exiting through the horizontal outlet tube 93 is only capable of overcoming a predetermined water pressure. Once the water level in the mixing chamber 80 reaches a level corresponding to the predetermined water pressure as determined using a pressure valve (not shown), heated water would cease to flow out of the manifold until the water level (and the water pressure) dropped. Thus, the manifold design would aid in preventing the overflow of water in the mixing chamber 80.

The draining chamber 70 may be generally circular in shape. In one embodiment, a trough 71 runs along the outer portion of the draining chamber 70, and may be inclined downwards in a clockwise direction. The upper portion of the trough 71 may be positioned proximate to the exit port 81 and the lower portion of the trough 71 may be positioned proximate to a drain hole 72. The trough 71 is designed to move the flow of liquid entering the draining chamber 70 (i.e., fruit juice from the reamer and/or “sugar water” from the mixing chamber 80) towards the drain hole 72. In another approach, the draining chamber may also include a walled winding passageway (not shown) that directs the sugar water from the exit port 81 in a circuitous path to the drain hole 72.

An optional third chamber (not shown) may also be attached below the draining chamber 70. This third chamber may include a circular, declining trough. Any liquid that drains through the drain hole 72 in the draining chamber 70 would enter the third chamber. The spiraling motion of the liquid traveling down the circular trough further agitates the solution and thus aids in further mixing the sugar and water. The solution would then exit through a hole in the lowest portion of the third chamber.

The receptacle 50 (see FIG. 1) is preferably a pitcher-like container. The receptacle may include a spout (not shown) and a handle 52. The receptacle 50 is preferably clear and also includes a FILL line 53 and an ICE line 54 on the side of the receptacle . A lid 55 may also be hinged onto the top of the receptacle 50. The lid 55 may be generally concave in shape and may have a central aperture 56. In one embodiment, the drain hole 72 in the draining chamber 70 is positioned to drain the “sugar water” and/or fruit extract onto a portion of the lid 55 between the central aperture 56 and the perimeter of the lid 55. Thus, due to the concave shape of the lid 55, the “sugar water” and/or fruit extract that falls onto the lid 55 will drain towards the central aperture 56. This aids in further agitating, and thus mixing of the “sugar water.” Alternatively, the aperture 56 in the lid 55 is designed such that it is aligned with the drain hole 72 in the draining chamber 70 when the receptacle 50 is placed onto the main body 20 (or aligned with the hole in the third chamber if the optional third chamber is attached).

In operation, the user first positions the receptacle 50 onto the base plate 21. This ensures that liquid draining from the draining chamber 70 will flow into the receptacle 50. The user may then place a predetermined amount of sugar or powdered drink mix into the mixing chamber 80. A predetermined amount of water is then poured into the reservoir 22. The apparatus 1 is then powered “on” by pressing a push button ON/OFF switch. Once the switch is in the ON position, the heating element begins to heat the water in the reservoir 22. The heated water and steam are pumped out by a pump (not shown) through the inlet 24 and into the manifold 90 in the mixing chamber 80.

The heated water and steam that enters the manifold 90 travels through the manifold 90 and exits from the holes 93 in the horizontal tube outlet 94. The water exiting through the holes 93 in the manifold 90 enters the mixing chamber 80 and begins to mix with the sugar. As the water continues to heat up and empty through the manifold 90 and into the mixing chamber 80, the hot water bubbling out of the holes 93 creates surging and agitation in the “sugar water” to assist in stirring and melting of the sugar in the water.

As the water level rises, the “sugar water” begins to exit from the mixing chamber 80 into the draining chamber 70 through the exit port 81. The “sugar water” travels along the trough 71 in the draining chamber 70 to the drain hole 72. The trough 71 aids in further mixing the sugar and water together with fruit juice that may be extracted using the reamer 30. Once the “sugar water” enters the drain hole 72 it flows down into the receptacle 50.

Since the rate of water entering the mixing chamber 80 is greater than the flow of “sugar water” through the exit port 81, the amount of water in the mixing chamber 80 continues to increase. If the “sugar water” level rises above the predetermined level of the outflow aperture 82, the “sugar water” will also flow out of the mixing chamber 80 through the overflow aperture 82 and into the draining chamber 70.

Within the mixing chamber 80, the heated water and steam continues to travel from the heating reservoir 22, through the manifold 90, and out the holes 94 in the manifold 90. The heated water and steam cause bubbling and motion in the sugar and water, thus aiding in the mixing process.

The user may also extract the juice from a fruit (such as a lemon or lime) to add flavor to the beverage. For example, in one embodiment, pressing a lemon against the top of the reamer 30 engages the operation of the reamer 30, causing the reamer 30 to begin to rotate. This rotating motion extracts the juice from the lemon. The lemon juice flows through the apertures 35 of the reamer 30 down into the draining chamber 70. Once in the draining chamber 70, the lemon juice flows through the trough 71 along the outer portion on the draining chamber 70 and into the drain hole 72, thus draining into the receptacle 50. The juice may be extracted from the fruit before, after, or during the heating of the water in the reservoir 22 and the mixing of the sugar with the heated water.

The extracted juice and the mixed sugar water flow out through the drain hole 72 in the draining chamber 70 and are collected in the receptacle 50 to form the finished beverage. The user may fill the receptacle 50 with ice to the ICE line 54 to cool the beverage as the receptacle 50 is being filled, and then may remove the receptacle 50 once the FILL line 53 has been reached. The addition of the ice may be desired to further dilute the mixture and may also aid in the mixing process.

It is noted that this appliance is not limited to mixing sugar with water. Any type of solid powder may be placed in the mixing chamber. Thus, this invention may also be used for mixing, for example, any pre-sweetened powdered drink, or hot chocolate. It may also be used to mix two powders simultaneously, such as an unsweetened powdered drink and sugar.

It is recognized that variations to the construction and design of the present apparatus can be made without departing from the spirit and scope of the present invention. In this regard, particular features could be added or particular features could be eliminated. Additionally, as is evident from the foregoing description, certain aspects of the present invention are not limited by the particular details of the examples illustrated herein, and it is therefore contemplated that still other modifications and applications, or equivalents thereof, will occur to those skilled in the art. It is accordingly intended that the claims shall cover all such modifications and applications that do not depart from the spirit and scope of the present invention.

What is claimed is:

1. An apparatus for mixing a beverage comprising:
a base having a reservoir for receiving and heating a predetermined amount of liquid; and
a mixing chamber for receiving a predetermined level of a powdered material,
a manifold having an inlet fluid-coupled to the reservoir and an outlet fluid-coupled to the mixing chamber, the outlet being disposed in the mixing chamber below the predetermined level;
wherein liquid heated in the reservoir is delivered from the reservoir through the manifold and into the mixing chamber through the outlet such that the liquid mixes with the powdered material.

2. The apparatus of claim 1, wherein the mixing chamber is removable from the base.

3. The apparatus of claim 1, wherein the outlet is located proximate to a floor of the mixing chamber.

4. The apparatus of claim 3, wherein the outlet is a horizontal slit.

5. The apparatus of claim 1, further comprising:
a draining chamber fluid-coupled to the mixing chamber via an exit port located on
a dividing wall between the draining chamber and the mixing chamber.

6. The apparatus of claim 5, wherein the exit port is constructed such that a flow rate of liquid and sugar mix from the mixing chamber into the draining chamber via the exit port is less than a flow rate of liquid entering the mixing chamber via the manifold.

7. The apparatus of claim 6, further comprising:
an overflow aperture disposed on a higher portion of the dividing wall than the exit port.

8. The apparatus of claim 7, wherein the draining chamber further comprises:
an inclined trough descending from a region adjacent to the exit port to a drain hole.

9. The apparatus of claim 8, further comprising:
a reamer disposed substantially above the draining chamber for extracting juice from a food product and delivering the extracted juice to the draining chamber.

10. The apparatus of claim 9, further comprising:
a receptacle for containing the beverage, the receptacle being removably inserted on the base such that the receptacle is fluid-coupled to the draining chamber via the drain hole.

11. An apparatus for mixing a beverage comprising:
first receiving means for receiving a predetermined amount of liquid;
second receiving means for receiving a predetermined level of a powdered material; and
delivery means for delivering the liquid from the first receiving means to the second receiving means at a level below the predetermined level, to mix the beverage.

12. The apparatus of claim 11, further comprising:
first draining means for draining the mixed beverage from the second receiving means;
wherein the first draining means drains the mixed beverage at a rate slower than a rate of delivery of liquid by the delivery means.

13. An apparatus for mixing a beverage comprising:
a main body comprising a reservoir for receiving a predetermined amount of heated liquid; and
a basket comprising:
a mixing chamber for receiving a predetermined level of a powdered material;
a manifold disposed within the mixing chamber, the manifold having an inlet fluid-coupled to the reservoir and an outlet fluid-coupled to the mixing chamber, the outlet being disposed in the mixing chamber below the predetermined level; and
a draining chamber which receives liquid from the mixing chamber;
wherein the heated liquid in the reservoir is delivered from the reservoir through the manifold and into the mixing chamber through the outlet such that the liquid mixes with the powdered material.

14. The apparatus of claim 13, wherein the manifold comprises:
a first vertical chamber operably connected to the inlet; and
a second vertical chamber fluid-coupled to the first vertical chamber.

15. The apparatus of claim 14, wherein the outlet of the manifold comprises a horizontal tube.

16. The apparatus of claim 15, wherein the outlet includes a plurality of apertures.

17. The apparatus of claim 15, wherein the outlet is disposed adjacent a floor of the mixing chamber.

18. The apparatus of claim 13, wherein the mixing chamber is fluid-coupled to the draining chamber via an exit port in a dividing wall between the mixing chamber and the draining chamber.

19. The apparatus of claim 18, wherein the exit port is at least one aperture.

20. The apparatus of claim 13, wherein a rate of liquid flow from the mixing chamber is less than a rate of flow of liquid entering the mixing chamber through the manifold.

21. The apparatus of claim 18, wherein the mixing chamber includes an overflow aperture on the dividing wall between the mixing chamber and the draining chamber.

22. The apparatus of claim 21, wherein the overflow aperture is a horizontal slit.

23. The apparatus of claim 21, wherein the overflow aperture is disposed above a floor of the mixing chamber.

24. The apparatus of claim 21, wherein the floor of the mixing chamber is sloped down toward the dividing wall.

25. The apparatus of claim 15, wherein the manifold further comprises:
an air hole; and
a valve which seals the air hole.

26. The apparatus of claim 19, wherein the draining chamber includes a trough disposed along an outer portion of the draining chamber and a drain hole.

27. The apparatus of claim 26, wherein the trough is inclined downwards and disposed proximate the exit port.

28. The apparatus of claim 20, wherein the draining chamber includes a walled winding passageway that directs liquid from the exit port to the drain hole.

29. The apparatus of claim 20, further comprising a receptacle disposed within an aperture in the main body and located beneath the drain hole.

30. The apparatus of claim 13, further comprising a reamer disposed above the basket, which is driven by a motor.

31. The apparatus of claim 30, further comprising a reamer cap removably attached to the reamer.

32. The apparatus of claim 29, wherein the receptacle includes a first fill line for ice and a second fill line for the liquid exiting through the drain hole.

33. A method of mixing a beverage comprising:
receiving a predetermined amount of heated liquid in a reservoir;
receiving a predetermined level of powdered material in a mixing chamber, and
delivering a heated liquid from the reservoir to the mixing chamber at a level below the predetermined level of powdered material.

34. A method of mixing a beverage comprising:
placing a predetermined amount of powdered material into a mixing chamber;
pouring a predetermined amount of water in a reservoir adapted to heat the water;
receiving a first liquid containing the water and the powdered material into a manifold and then into a mixing chamber; and
draining the first liquid from the mixing chamber into the draining chamber through an exit port and into a receptacle disposed beneath the draining chamber.

35. The method of claim 34, wherein a second liquid entering from a reamer into the draining chamber is mixed with the first liquid in the draining chamber.
